(19) United States
(12) Patent Application Publication
(10) Pub. No.: US 2009/0094459 A1
(43) Pub. Date: Apr. 9, 2009

(54) METHOD AND SYSTEM FOR ASSOCIATING ONE OR MORE PESTWARE-RELATED INDICATIONS WITH A FILE ON A COMPUTER-READABLE STORAGE MEDIUM OF A COMPUTER

(76) Inventor: Jerome L. Schneider, Boulder, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/869,532

(22) Filed: Oct. 9, 2007

(51) Int. Cl. H04L 9/00

(52) U.S. Cl. 713/178

(57) ABSTRACT

A method and system for associating one or more pestware-related indications with a file on a computer-readable storage medium of a computer is described. One embodiment acquires pestware-related information about the file and alters an existing value of at least one attribute stored in association with the file on the computer-readable storage medium and generated by an operating system of the computer so as to provide at least one pestware-related indication about the file based on the acquired pestware-related information, the at least one pestware-related indication being usable by an anti-pestware application in determining whether subsequently to scan the file for pestware.

### RELATED APPLICATIONS

The present application is related to the following commonly owned and assigned patent applications: U.S. application Ser. No. (unassigned), Attorney Docket No. WEBR-066/00US, entitled “Method and System for Efficiently Scanning a Computer Storage Device for Pestware,” filed herewith; U.S. application Ser. No. 11/237,575, Attorney Docket No. WEBR-025/00US, entitled “System and Method for Removing Residual Data from Memory,” filed on Sep. 28, 2005; U.S. application Ser. No. 11/386,594, Attorney Docket No. WEBR-040/00US, entitled “Method and System for Rapid Data-Fragmentation Analysis of a New Technology File System (NTFS),” filed on Mar. 22, 2006; and U.S. application Ser. No. 11/363,819, Attorney Docket No. WEBR-042/00US, entitled “System and Method for Obtaining File Information and Data Locations,” filed on Feb. 28, 2006; each of which is incorporated herein by reference in its entirety.

### FIELD OF THE INVENTION

The present invention relates to computer system management. In particular, but not by way of limitation, the present invention relates to methods and systems for controlling pestware or malware.

### BACKGROUND OF THE INVENTION

Personal computers and business computers are continually attacked by viruses, trojans, worms, BOTs (for remotely installing and executing malware applications), spyware, keyloggers, adware, and other forms of “malware” or “pestware.” Such programs are referred to hereinafter collectively as “pestware.” Some types of pestware (e.g., spyware) gather information about a person or organization-often without the person or organization's knowledge. Some pestware is highly malicious. Other pestware is non-malicious but may cause issues with privacy or system performance.

Software is available to detect and remove pestware, but scanning a system for pestware “on demand” (when scheduled or requested by a user) typically requires a system to look at files stored in a data storage device (e.g., a hard disk drive) on a file-by-file basis. This process of scanning files on demand is frequently time consuming, especially if every file on the data storage device is to be analyzed. As a result, users must wait a substantial amount of time to find out the results of a complete system scan. Even worse, some users elect not to perform a complete system scan because they do not want to, or cannot, wait for such a time-consuming scan to be completed. Moreover, “on-access” scanning, in which a file is scanned in response to its being written to a storage device or in response to an attempt to access the file (e.g., to open or execute the file) to prevent harm to the system, slows system response, making the system appear sluggish. In both on-demand and on-access scanning, files that have already been analyzed and that have already been determined not to be pestware may end up being needlessly and repeatedly rescanned.

Accordingly, current software is not always able to scan and remove pestware in an efficient, convenient manner and will most certainly not be satisfactory in the future as the capacity of computer storage devices continues to increase.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The invention can provide a method and system for associating one or more pestware-related indications with a file on a computer-readable storage medium of a computer. One embodiment is a method for associating one or more pestware-related indications with a file on a computer-readable storage medium of a computer, the method comprising acquiring pestware-related information about the file and altering an existing value of at least one attribute stored in association with the file on the computer-readable storage medium so as to provide at least one pestware-related indication about the file based on the acquired pestware-related information, wherein the existing value of the at least one attribute is generated by an operating system of the computer and the at least one pestware-related indication is usable by an anti-pestware application in determining whether subsequently to scan the file for pestware.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a block diagram of a computer equipped with an anti-pestware application in accordance with an illustrative embodiment of the invention;

FIG. 2 is flowchart of a method for associating one or more pestware-related indications with a file in accordance with an illustrative embodiment of the invention; and

FIG. 3 is a partial and exploded view of an entry in the file table depicted in FIG. 1 in accordance with an illustrative embodiment of the invention.

### DETAILED DESCRIPTION

In various illustrative embodiments of the invention, protecting a computer from pestware is made more efficient by acquiring pestware-related information about a file stored on a computer-readable storage medium. This pestware-related information can be obtained in a variety of ways. For example, such pestware-related information can be acquired by analyzing the file for pestware. Such information can also be obtained without analyzing the file for pestware. For example, it may be known that the file was downloaded from a particular source that is known to be trustworthy. Likewise, it may be known that the file was downloaded from a particular source that is known to be untrustworthy (e.g., a Web site that is a known source of pestware).

Once pestware-related information about the file has been acquired, one or more existing attributes stored in association with the file by the computer's operating system can be altered so as to provide one or more pestware-related indications about the file based on the acquired pestware-related information. An anti-pestware application can then use these pestware-related indications in determining whether subsequently to scan the associated file for pestware.

The pestware-related indications derived from the acquired pestware-related information can be any of a wide variety. Examples include, without limitation, whether the file has been analyzed to determine whether it is a potential pestware file; when that analysis, if any, was performed; whether the file has been determined to be a potential pestware file through analysis of the file or by some other means, and what version of a set of pestware definitions was used to analyze the file. Those skilled in the art will recognize that other kinds of pestware-related indications may be useful to an anti-pestware application.

If the anti-pestware application determines from one or more associated pestware-related indications that the file is not a potential pestware file, it can avoid scanning the file needlessly. This saving of effort and improved efficiency applies to both on-demand pestware scans and on-access pestware scans.

As discussed above, an “on-demand” pestware scan involves scanning files (often substantially all of the files) on a storage device when scheduled or when requested by a user. Such a scan is typically performed at some regularly scheduled interval (e.g., daily, weekly, or monthly). “On-access” scanning involves scanning a file in response to the file being written to the storage device or in response to the file being accessed (e.g., opened or executed). If the file is determined, in an on-access scan, to be a pestware file, the attempted file-write or file-access operation can be prevented before harm is done to the computer.

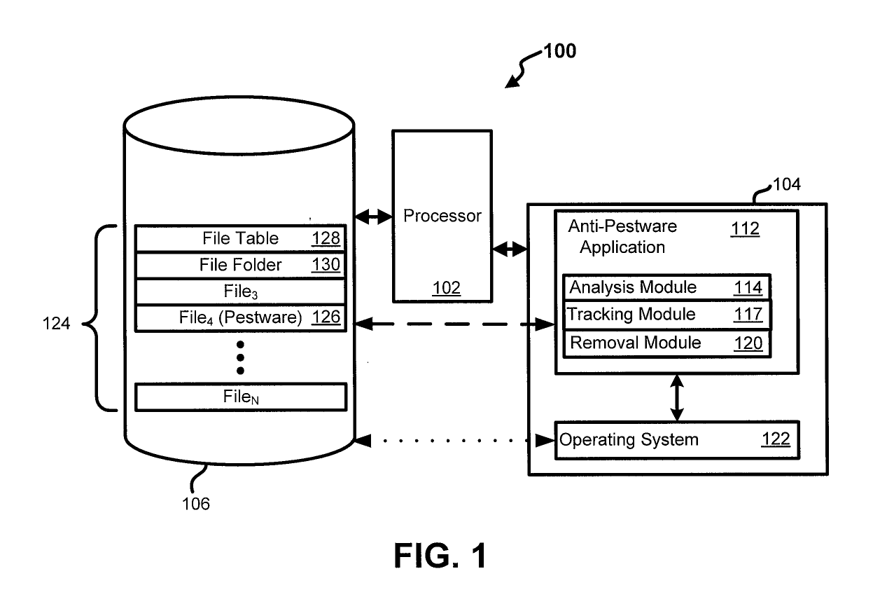

Referring now to the drawings, where like or similar elements are designated with identical reference numerals throughout the several views, and referring in particular to FIG. 1, it is a block diagram of a digital computer (“computer”) 100 that is protected in accordance with one implementation of the present invention. The term “computer” is used herein to refer to any type of computer system, including personal computers, handheld computers, servers, firewalls, etc. This implementation includes a processor 102 coupled to memory 104 and a storage device 106. Memory 104 may include random-access memory (RAM), read-only memory (ROM), flash memory, or other types of memory.

As shown in FIG. 1, storage device 106 provides storage for a collection of N files 124, which includes a pestware file 126, a file table 128, and a file folder 130, among other files. Storage device 106 is, in one implementation, a hard disk drive (HDD), but it is contemplated that other computer-readable storage media may be utilized without departing from the scope of the present invention. For convenience, however, embodiments of the present invention are generally described herein with relation to disk-drive-based systems. In addition, one of ordinary skill in the art will recognize in light of this disclosure that the storage device 106, which is depicted for convenience as a single storage device, may be realized by multiple (e.g., distributed) storage devices. In general, storage device 106 includes one or more computer-readable storage media containing a collection of N files 124.

Although each of the N files 124 is depicted, for convenience, as a contiguous portion of the storage device 106, it should be recognized that in many instances several of the N files 124 may each be fragmented and dispersed over noncontiguous portions of the storage device 106.

The file table 128 in this embodiment is a file that includes an entry (also referred to herein as a record) for each of the files 124 on the data storage device 106, including the file table 128 itself and each of the other files. Each entry (not shown) in the file table 128 includes a set of attributes (also referred to herein as attribute information), which includes information about the corresponding file (e.g., the file's name, date and time of creation, date and time of last modification, date and time of last access, file type, alternate data streams, security information, and pointers to data locations (also referred to herein as data runs). In one embodiment, as described further herein, the file table 128 is a Master File Table (MFT) organized in accordance with a new technology file system (NTFS) sold under the trade name of MICROSOFT CORP., but this is certainly not required in all embodiments.

As shown in FIG. 1, an anti-pestware application 112 includes an analysis module 114, a tracking module 117, and a removal module 120. These functional modules may be implemented in hardware, firmware, software, or any combination thereof. Also, the functionality of these modules may be subdivided or combined in ways different from that indicated in FIG. 1, depending on the particular embodiment. In one embodiment, the above functional modules are implemented in software and are executed from the memory 104 by the processor 102. In such an embodiment, each of the above functional modules may be implemented as a particular instruction segment (e.g., subroutine or function) on a computer-readable storage medium. Such a computer-readable storage medium may be, for example, a magnetic disk, an optical disc, or a flash-memory-based storage device. In addition, an operating system 122 is depicted, in FIG. 1, as running from memory 104.

In various illustrative embodiments, analysis module 114 is configured to acquire pestware-related information about files 124 on storage device 106. As explained above, this acquiring of pestware-related information about a file 124 can be accomplished in various ways, depending on the particular embodiment and situation. Analysis module 114 may be configured, in some instances, to acquire pestware-related information about files 124 without analyzing their contents. For example, anti-pestware application 112 may include a database (not shown) of known trustworthy or untrustworthy sources of programs and data (e.g., Web sites that are know to be trustworthy or that are known to be sources of pestware). If analysis module 114 determines that a file 124 was received from one of these known sources, analysis module 114 can annotate the file 124 accordingly to provide useful information to analysis module 114 during subsequent on-demand or on-access pestware scans, as described below.

Analysis module 114 may be configured to perform on-demand scans of files 124 for pestware, on-access scans of files 124 for pestware, or both, as needed. Depending on the particular embodiment, analysis module 114 may be configured to detect both obfuscated (e.g., encrypted pestware) pestware and pestware that is identifiable by established techniques (e.g., by comparing information in the files 124 with known pestware definitions).

In some embodiments, only one or more selected portions of a file 124 are retrieved and analyzed unless it is desirable to retrieve additional portions. In some embodiments for example, a first portion (e.g., a first cluster) of a file 124 is analyzed to determine whether it is desirable to have any additional portions of the file 124 available before analyzing the retrieved information for indicia of pestware. As an example, if the first portion of the file 124 reveals that the file 124 is a text file, then the first portion of the text file is analyzed for indicia of pestware, and subsequent portions of the file 124 may be ignored, but if the file 124 is an executable file, then one or more additional portions of the executable file may be retrieved from the storage device.

As another example, if an analysis of a first portion and second portion of the file 124 indicates with substantial certainty that the file 124 is a pestware file, then analysis module 114 may ignore subsequent portions of that file 124. It has been found that, in many instances a determination may be made as to whether a file is malicious or not with only a small portion (e.g., 30%) of an entire file. As a consequence, an effective scan for pestware may be carried out while substantially reducing scan times by selectively retrieving only portions of each file on the storage device.

Tracking module 117 is configured to alter one or more existing operating-system-generated attributes associated with a given file 124 so as to provide at least one pestware-related indication about the file 124 based on the pestware-related information acquired by analysis module 114, however that pestware-related information was obtained. Examples of such pestware-related indications are listed above. In some embodiments, the existing operating-system-generated attributes include one or more of the creation time, modification time, and last-access time. Further details regarding the altering of file attributes is provided below.

During subsequent on-demand or on-access pestware scans by analysis module 114, pestware-related indications that have previously been associated with a file 124 by tracking module 117 may allow analysis module to skip that file 124 altogether. For example, a pestware-related indication may indicate that the file 124 is known not to be a pestware file, either because of a prior analysis or because of other information (e.g., knowledge that the file 124 originated from a trustworthy source). In some embodiments, additional information such as the level of completeness of the previous pestware scan of a file 124 may also be included among the pestware-related indications associated with that file 124.

Anti-pestware application 112 may also include, in some embodiments, removal module 120. Removal module 120 is configured to quarantine and/or remove pestware files detected by analysis module 114.

In the present embodiment, the operating system 122 is not limited to any particular type of operating system and may be operating systems provided by MICROSOFT CORP. under the trade name WINDOWS (e.g., WINDOWS 2000, WINDOWS XP, WINDOWS NT, WINDOWS VISTA, etc.). In other embodiments, the operating system 122 is an open-source operating system such operating systems distributed under the LINUX trade name. For convenience, however, embodiments of the present invention are generally described herein with relation to WINDOWS-based systems. Those of skill in the art can easily apply the principles of the invention to other types of operating systems or computer systems.

Although certainly not required, in some illustrative embodiments, one or more of the various modules of anti-pestware application 112 are configured to access information from the storage device 106 via direct drive access (e.g., without using calls to the operating system 122). Such an approach can substantially increase the rate at which information is retrieved from storage device 106 while also allowing anti-pestware application 112 to thwart particular varieties of pestware (e.g., rootkits), which are known to patch, hook, or replace system calls with versions that hide information about the pestware.

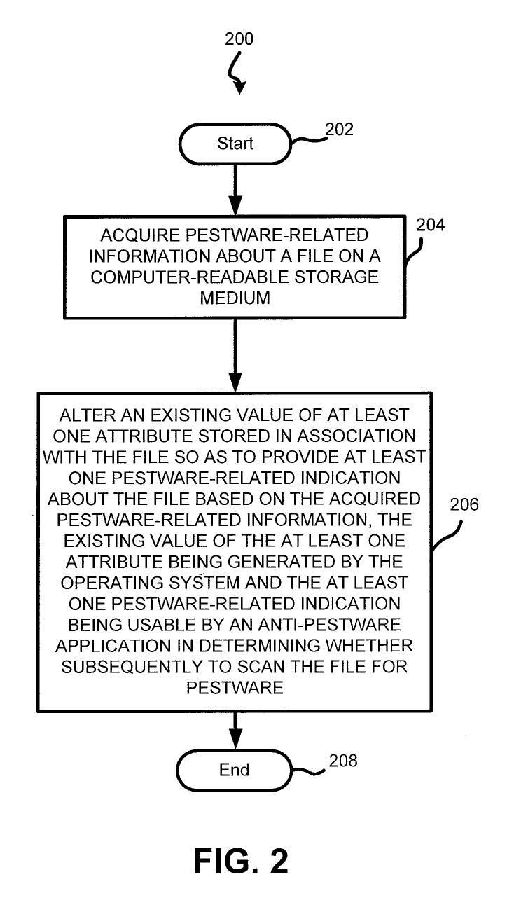

Referring next to FIG. 2, shown is a flowchart 200 depicting a method for associating one or more pestware-related indications with a file on a computer-readable storage medium of a computer in accordance with an illustrative embodiment of the invention. The method begins at 202. At 204, analysis module 114 acquires pestware-related information about a file 124 on a computer-readable storage medium of computer 100.

At 206, tracking module 117 alters an existing value of at least one operating-system-generated attribute stored on the computer-readable storage medium in association with the file 124 so as to provide at least one pestware-related indication about the file 124 usable by analysis module 114 in subsequent on-demand or on-access pestware scans, as explained above. The method terminates at 208. Of course, the method depicted in flowchart 200 may be applied to any number of files 124 on storage device 106.

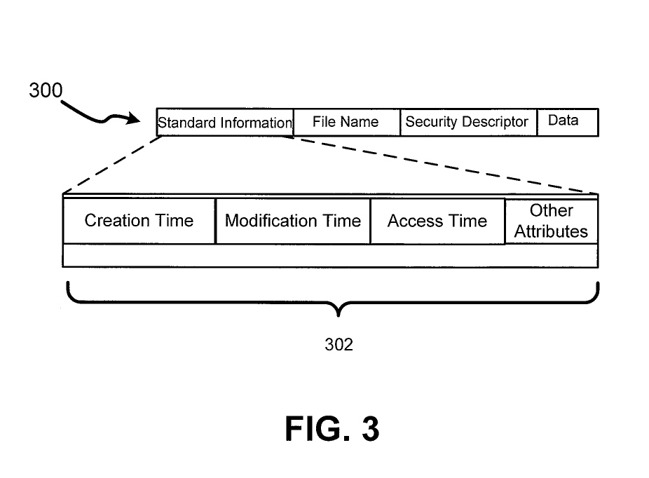

Referring briefly to FIG. 3, for example, shown is an exemplary entry 300 for a file 124 in file table 128. As shown, entry 300 includes standard information, a file name, security descriptor information, and data for the file 124. As depicted, the standard information includes attribute information 302, also known as metadata, including creation-time, modification-time, and access-time attributes, as well as other attributes. In accordance with several embodiments, tracking module 117 records one or more pestware-related indications about a given file 124 by commingling added data with existing attribute data. In some embodiments, for example, relatively insignificant bits of one or more of the existing attribute values are altered so as to add one or more pestware-related indications about the file 124 to the attribute information 302 without increasing the number of bits used for the attributes and without affecting the nominal utility of those attributes.

As an example, most operating systems store file timestamps with a particular number of bits that enable the captured times to be stored with a very detailed precision. But the times typically can not be predictably generated with an accuracy equal to the precision at which they may be stored. In some embodiments, the difference between the effective low-resolution accuracy of the information stored for an attribute (e.g., a timestamp attribute) and the ultra-granular precision available for the attribute value is utilized to encode information for other purposes (e.g., one or more pestware-related indications) without materially affecting the meaning of the timestamps.

For example, in many file systems, the file timestamp is stored as a 64-bit value. But the generation of a file timestamp by many operating systems is accurate to within approximately one millisecond. Therefore, the fractional portion of the timestamp less than one millisecond can be any value in these systems without impairing the utility of the timestamp. In such operating systems, there are roughly 10 least-significant-bits within the 64-bit timestamp that can be set to any value without affecting the useful accuracy of the timestamp. In other embodiments, this number of usable least-significant bits may differ from 10. The use of the number 10 in this example is merely illustrative.

By suitably combining the pestware-related-indications data with other constant or variable data such as the file's creation time and perhaps a machine-unique value, an apparently-random 10-bit value can be generated to replace the least-significant 10 bits of a file's timestamp, without materially affecting the timestamp's normal uses.

Most files have several timestamps, notably one each for file creation time, file modification time, and file access time. Because the lower 10-bits of the both the file's creation and modification time can be replaced, the two represent a 20-bit binary value that can store one or more pestware-related indications made up of pestware-related-indications data, machine-unique data, and some variable data. In some embodiments, tracking module 117 is configured to encrypt the resulting pestware-related indications to protect them against discovery and/or tampering by pestware programs. By decrypting these 20 bits of information at a later time, analysis module 114 can recover the originally stored pestware-related-indications data while simultaneously insuring that a machine-unique value and other data present during encryption matches the decrypted result. Information that does not match may be considered to be invalid.

The likelihood that random values in the lowest 10-bits of both the file-creation and file-modification times will represent false (incorrect) pestware-related information is extremely low. In the above-described embodiment, the probability of 20 random bits indicating a valid, unique value is approximately 1 in 1,048,575. If this is not a tolerable probability, then it is necessary to utilize more than 20 bits of the two timestamp values. One way of doing this is to store file-create and file-modification times accurate to only 2, 4 or 8 milliseconds, which would give 22, 24 or 26 bits, respectively, for storing the one or more encrypted pestware-related indications, decreasing the probability of false “hits” or “misses” to as low as 1 in 33,554,431.

In many embodiments, when the least-significant bits of a file timestamp are replaced, the one or more pestware-related indications encoded into the timestamp are constrained so that when the information is added to the file timestamp (by altering the timestamp) the resulting time is never made greater (e.g., newer) than its original value. This may be implemented by decrementing the actual timestamp by 1 if the original fractional value was less than ½ LSB and the replacement value is more than ½ LSB.

It is contemplated that when writing to (e.g., modifying) a file with altered timestamps the “usurped” timestamp bits are changed into a non-valid pattern in order to prevent the timestamp from being recognized as valid after the write. In many operating systems, file I/O is performed using virtual memory with a caching mechanism, in addition to conventional filesystem operations. Trapping such non-conventional file modification operations that do not automatically update the file's “modified” metadata (such as the file's modification timestamp) allows replacement of the formerly valid timestamp metadata.

It is possible that sophisticated pestware may be capable of modifying files by directly accessing (e.g., without using OS system calls) the storage medium (e.g., the storage device 106). In such a case, pestware may be able to modify a file 124 without effecting any change in the encoded pestware-related indications associated with the file. As a consequence, in some embodiments, raw disk I/O is trapped and inspected to prevent pestware from surreptitiously modifying files.

As explained above, once the attribute value or values have been altered so as to provide the one or more pestware-related indications, the file 124, under the appropriate circumstances based on the content of the one or more pestware-related indications, may be skipped during subsequent on-demand or on-access pestware scans until the circumstances indicate otherwise (e.g., the file has been modified). In some embodiments, the file table 128 is accessed and the applicable attribute values (e.g., timestamps) for each file are analyzed to determine whether those attribute value(s) include one or more pestware-related indications placed there by tracking module 117. If so, the associated files 124 can be handled in accordance with the one or more associated pestware-related indications during an on-demand or on-access pestware scan. For example, files 124 that do not need to be scanned for pestware at the time can be omitted from the scan.

In conclusion, the present invention provides, among other things, a method and system for associating one or more pestware-related indications with a file on a computer-readable storage medium of a computer. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A method for associating one or more pestware-related indications with a file on a computer-readable storage medium of a computer, the method comprising:
acquiring pestware-related information about the file; and
altering an existing value of at least one attribute stored in association with the file on the computer-readable storage medium so as to provide at least one pestware-related indication about the file based on the acquired pestware-related information, wherein the existing value of the at least one attribute is generated by an operating system of the computer and the at least one pestware-related indication is usable by an anti-pestware application in determining whether subsequently to scan the file for pestware.

2. The method of claim 1, wherein acquiring pestware-related information about the file includes analyzing the file to determine whether the file is a potential pestware file.

3. The method of claim 2, wherein the analyzing is performed during an on-demand pestware scan of the computer-readable storage medium.

4. The method of claim 2, wherein the analyzing is performed in response to the file being written to the computer-readable storage medium.

5. The method of claim 2, wherein the analyzing is performed in response to the file being accessed.

6. The method of claim 1, wherein acquiring pestware-related information about the file includes determining whether the file is a potential pestware file without analyzing the file's contents.

7. The method of claim 1, wherein acquiring pestware-related information about the file includes ascertaining that the computer received the file from a trustworthy source.

8. The method of claim 1, wherein acquiring pestware-related information about the file includes ascertaining that the computer received the file from an untrustworthy source.

9. The method of claim 1, wherein the at least one pestware-related indication includes an indication that the file has been analyzed to determine whether the file is a potential pestware file.

10. The method of claim 1, wherein the at least one pestware-related indication includes an indication of whether the file has been determined to be a potential pestware file.

11. The method of claim 1, wherein the existing value of the at least one attribute includes a particular number of bits and wherein the altering does not change the particular number of bits.

12. The method of claim 1, wherein the at least one attribute includes a timestamp.

13. The method of claim 12, wherein the timestamp is one of a creation timestamp, a modification timestamp, and an access timestamp.

14. The method of claim 1, wherein the existing value of the at least one attribute includes a collection of bits and the altering includes altering least-significant ones of the collection of bits while leaving more-significant ones of the collection of bits unaltered.

15. The method of claim 14, wherein the altering includes altering ten of the least-significant ones of the collection of bits while leaving the more-significant ones of the collection of bits unaltered.

16. The method of claim 1, wherein the altering includes altering existing values of at least two attributes that are stored in association with the file so as to provide the at least one pestware-related indication about the file based on the acquired pestware-related information.

17. The method of claim 1, wherein the altering includes encrypting the at least one pestware-related indication about the file.

18. A digital computer, comprising:
at least one processor;
a computer-readable storage medium containing a plurality of files; and
a memory containing a plurality of program instructions, the plurality of program instructions including:
a pestware analysis module configured to cause the at least one processor to acquire pestware-related information about a file on the computer-readable storage medium; and
a pestware tracking module configured to cause the at least one processor to alter an existing value of at least one attribute stored in association with the file on the computer-readable storage medium so as to provide at least one pestware-related indication about the file based on the acquired pestware-related information, wherein the existing value of the at least one attribute is generated by an operating system of the digital computer and the at least one pestware-related indication is usable by the pestware analysis module in determining whether subsequently to scan the file for pestware.

19. The digital computer of claim 18, wherein the pestware analysis module is configured to cause the at least one processor to acquire pestware-related information about the file by analyzing the file to determine whether the file is a potential pestware file.

20. The digital computer of claim 18, wherein the pestware analysis module is configured to cause the at least one processor to acquire pestware-related information about the file by determining whether the file is a potential pestware file without analyzing the file's contents.

21. The digital computer of claim 18, wherein the at least one attribute includes a timestamp.

22. The digital computer of claim 21, wherein the timestamp is one of a creation timestamp, a modification timestamp, and an access timestamp.

23. The digital computer of claim 18, wherein the pestware tracking module is configured to cause the at least one processor to alter an existing value of each of at least two attributes stored in association with the file so as to provide the at least one pestware-related indication about the file based on the acquired pestware-related information.

24. The digital computer of claim 18, wherein the pestware tracking module is configured to cause the at least one processor to encrypt the at least one pestware-related indication about the file.

25. A computer-readable storage medium containing a plurality of program instructions executable by a processor, the plurality of program instructions comprising:
a first instruction segment configured to cause the processor to acquire pestware-related information about the file; and
a second instruction segment configured to cause the processor to alter an existing value of at least one attribute stored in association with the file on the computer-readable storage medium so as to provide at least one pestware-related indication about the file based on the acquired pestware-related information, wherein the existing value of the at least one attribute is generated by an operating system of the computer and the at least one pestware-related indication is usable by the first instruction segment in determining whether subsequently to scan the file for pestware.
